(19) United States
(12) Patent Application Publication
(10) Pub. No.: US 2007/0002130 A1
(43) Pub. Date: Jan. 4, 2007

(54) Method and apparatus for maintaining eye contact during person-to-person video telecommunication

(76) Inventor: David Hartkop, Central Point, OR (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/157,884

(22) Filed: Jun. 21, 2005

(51) Int. Cl. H04N 7/14

(52) U.S. Cl. 348/14.16

(57) ABSTRACT

The apparatus and method for maintaining eye contact during person to person video telecommunication includes disposing a video camera directly behind an OLED video display screen and synchronizing the video camera with the illumination levels of the display screen. This configuration allows the camera to observe the user from a natural face-on perspective, and effectively reconnects the eye-lines of the users, and restores all natural face-to-face emotional cues ordinarily disrupted by eye-line dissociation. Some embodiments include the use of this technique for stand-alone monitors, handheld devices, laptop computers, and the potential use in conjunction with autostereoscopic display technology, including wide look around or head and eye-tracking, for 3 dimensional eye-to-eye telecommunication.

### BACKGROUND OF THE INVENTION

1. Field of the Invention

The present invention relates to person to person video conferencing. More particularly, it relates to a method and apparatus for maintaining eye contact during person to person video telecommunication.

2. Description of the prior art

Instantaneous two-way communication between individuals has been envisioned as the ultimate goal of telecommunications for longer than eighty years. A two-way video screen was pictured in Fritz Lang's 1929 science fiction film, “Metropolis.” This was the same year that Philo T. Farnsworth demonstrated his first prototype of the electronic television for David Sarnoff of RCA. By 1931, the idea of electronic visual communication was fully seated in popular culture at the time, as popularized in the comics Chester Gould, in which detective Dick Tracy communicates through his video wristwatch.

Throughout the 1950s, Bell Labs produced many various iterations of its video telephone technology. Their devices combined video cameras and television picture tubes in various interesting enclosures. The systems were typically quite bulky, as they were nearly all tube-based until the 1960s. They did provide working video communication, but were typically connected directly to one another, or in limited intercom networks.

With the advent of satellite communications and telephone networks in the 1960s to the 1990s, two-way video communication became more or less a reality. In most cases, it was reserved for highly specialized events or big-budget corporate events. Because sending two streams of video and audio is somewhat bandwidth intensive, videoconferencing systems relied on specialized video networks and were costly to set up and maintain. In 1992, AT&T released its Video Phone 2500, which it touted as the world's first color video telephone system. It had the advantage over nearly all previous generations of video communication devices in that it could use ordinary telephone lines. It was limited, however, by the fact that it retailed for over one thousand dollars, and it was necessary for both parties to have them in order to make use of the video feature.

The popularization and growth of the Internet as a public communications system sparked new interest in the videophone. By the late 1990s, there were several video-chat systems available on the market. These systems typically consisted of a miniature video camera and a live video compression application, and enabled true video chat. The bandwidth was very limited at first, but has grown along with new compression algorithms to allow for the full screen, full motion video chat that is enjoyed today in 2005.

Though the communications bandwidth and camera/display screen size issues have been largely solved, there still remain a few key problems to solve before face-to-face video communication can be fully accepted. One problem is that of the broken eye-line. This is a fundamental limitation of standard video chatting, and is caused by the users looking at their display screens, rather than into their cameras. The uncanny result is that both users observe each other in the act of looking off-screen. This effect hinders many of the usual facial cues of ordinary conversation, partly defeating the purpose of video communication. For many, the dissociation of eye contact is disconcerting and can be mistaken as distraction on the part of the other party. Though this dissociation can be intellectualized as a simple technical artifact of the system, it does not read well on an instantaneous emotional level.

Experiments have been conducted by placing the camera behind an angled pane of semi-reflective glass. The glass reflects the video screen's image from a position that is spatially similar to that of the camera. The technique is similar to the way that a video teleprompter displays the nightly news for a television anchor. This system works, but is too bulky for home or portable use.

Increasingly, the problem is being dealt with by making the cameras smaller and more easily attached to the computer monitor, thereby moving the camera as nearly as possible into the user's eye-line.

### SUMMARY OF THE INVENTION

The present invention addresses this broken eye-line problem by making use of recently developed OLED display technology and specialized camera syncing techniques.

The present invention allows a miniature video camera to be placed directly behind the middle of a video display screen, reconnecting the eye-line while at the same time allowing for a thin, flat-screen profile. It represents a true advance in the usability and appeal of video telecommunications, and can be implemented in a wide range of systems, from desktop displays to handheld devices. It uses materials that ultimately provide better image characteristics than standard LCD, and can be manufactured using less costly industrial techniques. The technology can be implemented in simple 2D form, or can be expanded to utilize autostereoscopic capture and display technology to produce truly face-to-face three-dimensional video communication.

According to one aspect of the invention, the apparatus for maintaining eye contact during person to person video telecommunication, the apparatus includes a display device for conducting person to person video telecommunications wherein the display device having a display matrix, and at least one video camera disposed behind said display matrix. The video camera preferably has a capture frame rate equivalent to a frame rate of the display device.

According to one preferred embodiment, the display device is an organic light emitting diode (OLED) display. The displace device may also include a substrate layer disposed between the display matrix and the video camera. The substrate layer operates to prevent light from the display matrix from being exposed to the video camera. According to other embodiments, more than one video camera is disposed behind the display screen, and each of the one or more video cameras preferably has a syncable shutter speed of greater than 1/60^{th} of a second.

The present invention may be embodied in a desktop and portable environment, where the portable device can be, for example, a personal digital assistant (PDA), a cellular telephone, a two way pager and/or a laptop computer.

According to yet another embodiment of the invention, the apparatus for maintaining eye contact during person to person video telecommunication includes a display device for providing a display of a display image source. The display device is capable of being used to conduct person to person video telecommunications and includes an image source having a frame rate and phase characteristics. A video camera is disposed behind the display matrix and having a shutter. The frame rate and phase characteristics of the display image source are used to drive the camera shutter.

In one embodiment, the frame rate and phase characteristics are offset in time. The offset in time sets the phase characteristic such that the camera shutter exposes in time when the display device is at a minimum illumination level. It is preferred that the video camera has a capture frame rate that is equal to the frame rate of the display device.

According to a further embodiment, the method for maintaining eye contact during person to person video telecommunication includes the steps of providing a display device, providing at least one video camera positioned behind the display device, and synchronizing the at least one video camera with the frame refresh rate and phase characteristics of the display image source.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 illustrates a profile view of one embodiment of the invention, showing the constituent layers;

FIG. 2 illustrates a profile view of one embodiment of the invention, showing the constituent layers and the outline of the device enclosure;

FIG. 3 illustrates a perspective view of one embodiment of the invention, showing the position of the invisible camera behind the screen;

FIG. 4 illustrates one embodiment of the invention as a computer peripheral or as a stand-alone video communication device;

FIG. 5 illustrates one embodiment of the invention as an autostereoscopic computer peripheral or as a stand-alone video communication device having two cameras for stereoscopic capture, head tracking, and/or pointer interface control;

FIG. 6 illustrates one embodiment of the invention as an autostereoscopic computer peripheral or as a stand-alone video communication device having an array of cameras for wide-parallax stereoscopic capture, head tracking, and/or pointer interface control;

FIG. 7 illustrates a cross section of one autostereoscopic embodiment of the invention, in which the OLED layer is separated from the LCD shutter plate by a solid transparent substrate of specific thickness;

FIG. 8 illustrates a cross section of one autostereoscopic embodiment of the invention, in which the OLED layer is separated from the LCD shutter plate by an air-gap of specific thickness;

FIG. 9 illustrates the invention being used to provide face-to-face video communication between two people by means of an Internet connection;

FIG. 10 illustrates one embodiment of the invention in which it is utilized in a handheld wireless communication device;

FIG. 11 illustrates one embodiment of the invention in which it is utilized in a laptop computer;

FIG. 12 is a flowchart representation of the method by which a clean output image is derived from a video camera behind a transparent OLED display according to an embodiment of the invention;

FIG. 13 is graphical timing diagram representation of the method according to an embodiment of the invention.

FIG. 14 illustrates one embodiment of the invention in which it is utilized as an expressive ‘face’ for a robot having machine vision.

### DETAILED DESCRIPTION OF PREFERRED EMBODIMENTS

The present invention is based on a system that enables miniature video cameras to be placed directly behind a video display screen. All embodiments use an emissive display technology such as, for example, Organic Light Emitting Diode (OLED) that is produced on a transparent or semi transparent substrate material. The miniature video camera or cameras are electronically configured so as to capture images of the subject without capturing light produced by the display screen through which they look. The camera can be used for either still or video capture. When two or more cameras are employed, they may be used for the purposes of autostereoscopic 3-D capture, for eye and head tracking for autostereoscopic display, and/or for the purposes of positioning the mouse pointer on the display screen in a hands-free manner.

According to one preferred embodiment of the present invention, the system 10 consists of a color video display monitor, which makes use of an OLED technology or other emissive display technology in order to form its images, and a miniature color video camera, which has the syncable shutter speed capacity faster than 1/60th of a second. The OLED display screen is formed through a deposition or printing process on the surface of a transparent or neutral-density substrate material, and can be driven by means of appropriate multiplexing video drivers to create a color video image that is capable of sustained frame or field rates of over 50 Hz. The video camera is placed directly behind the neutral density substrate, or behind an additional darkening neutral density filter in the case of a fully transparent substrate. The substrate totally obscures a user's view of the camera even when the monitor is in the “off” state, yet is transparent enough to allow a perfect view of the user by the camera.

FIG. 1 shows system 10 with the placement of a miniature video camera 12 behind the display matrix 16 and the substrate layer 14. The display surface 22 is further protected by a layer of glass or transparent plastic 18. The substrate 14 may be darkened plastic or glass and have the emissive display matrix 16 placed on its forward surface, such that light from the matrix shines outward to the user, else the display surface appears to be black. Additionally, the darkened nature of the substrate 14 obscures the user's view of the hidden camera, but does not block the video camera's view of the user through the substrate and display matrix.

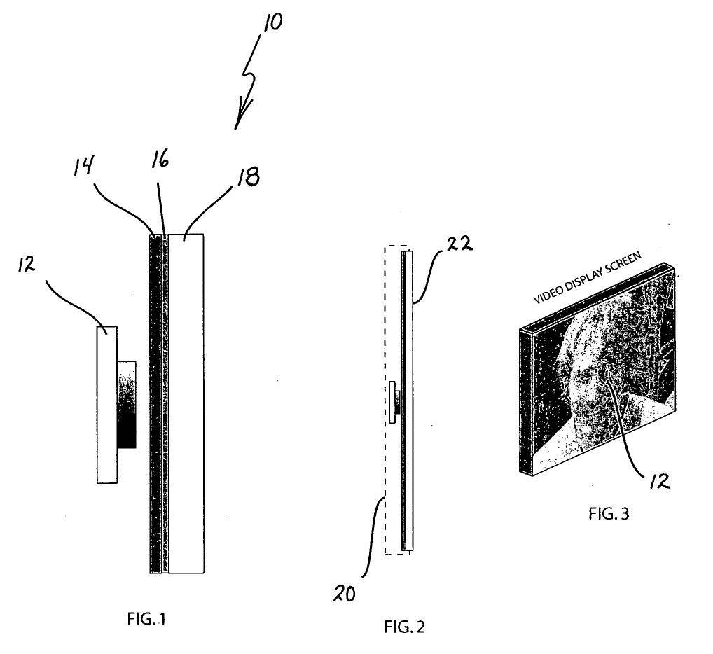

FIG. 2 shows the camera 12 and screen 22 encapsulated in a protective monitor housing 20. The housing 20 is formed to hold the video camera(s) 12 and is darkened inside to eliminate any light reflection from the screen. When the system is in operation, a video image is scanned by means of a bus network onto the OLED matrix such that the actual instantaneous illuminated area of the display is only a small traveling band of illuminated pixels. The rapidity of scan, however, is such that a steady full screen image will be perceived by the user. The video camera has its shutter speed and capture timing phase set such that it captures each successive frame in the interval between the times when OLED pixels directly in front of the camera are illuminated. In the event that longer exposure times may be desirable, or that it is desirable to retain some pixel illumination for longer periods of time, it is also feasible to remove display image feedback from the captured camera images by means of active electronic signal subtraction. In this case, a digital model of the display screen's illumination and camera position is used to remove additional chrominance and luminance level from the camera image before it is compressed and transmitted via the Internet.

FIG. 3 shows the display screen component of the embodiment in operation, whereas the video camera 12 is invisible and capable of simultaneous video capture of the screen's user without optical interference from images displayed on the screen.

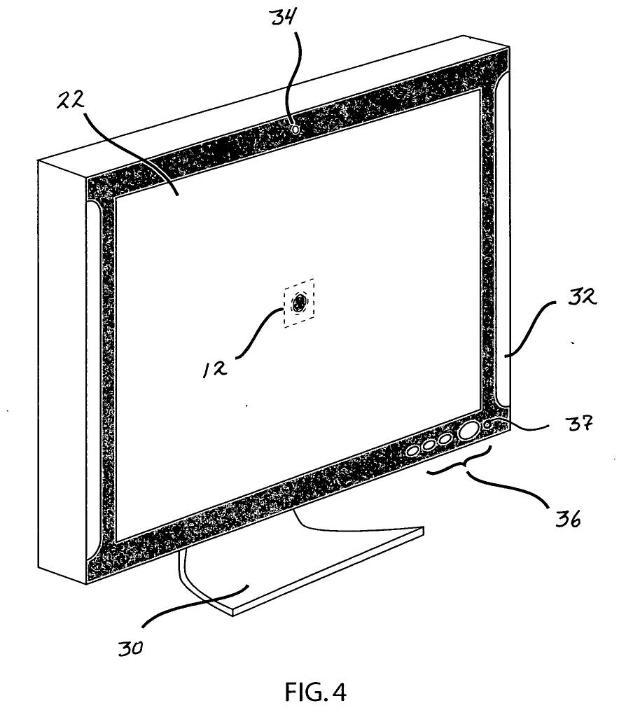

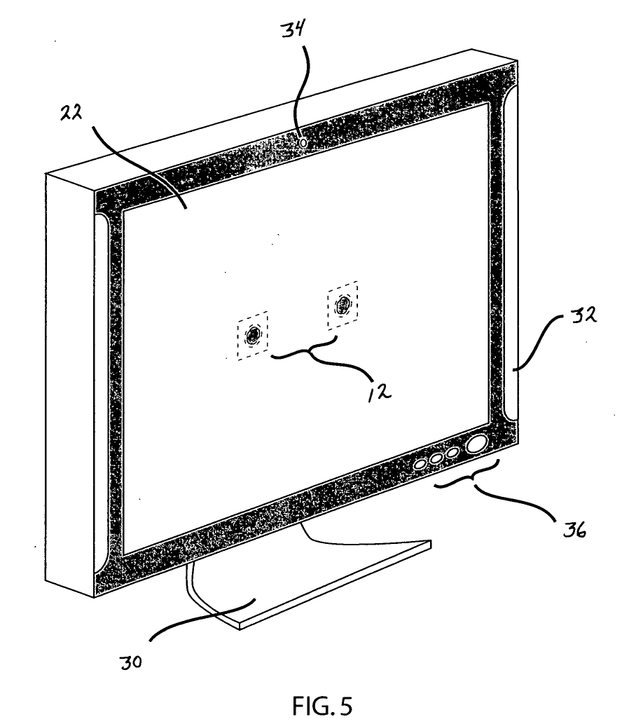

As shown in FIG. 4, the monitor is created as a thin flat screen type display that has means for angle adjustability, as provided by arrangement of the base 30. The position of the video camera 12 is shown in dotted lines to demonstrate that it is placed directly behind and within the surface area of the display 22. Additionally, the display screen may be fitted with several features that enhance its utility as a video telecommunication device.

These features can include integrated subject lighting 32 which can be either LED, CCT, or Halogen lights built into the shell of the monitor surrounding the display screen. These lights are directed outward at the user's face at a comfortable level, and simply provide soft illumination for the camera's view. Any integrated lighting systems would have some means of software control, similar to the monitor brightness features already built into computer displays. They could additionally work in conjunction with the camera's detected light-levels, increasing or decreasing in illumination to match the need for a given scenario.

Another secondary feature may include a built-in microphone pickup 34. The microphone 34 may be either of the omni directional or short-shotgun hypercardioid type, and will be built into or closely attached to the device itself. The display may also include amplified audio speakers (not shown).

Another feature may be an indicator light built into the frame, set behind the display screen, or closely associated with the device and which serves as an indicator of camera activation. This feature is integral to the perceived privacy and security of the device. As an alternative, a camera activation indicator will be made to appear on the screen when the camera is active. The indicators of camera activity may be included in the control area 36, or may be completely independent from controls 36. The camera may also be instantaneously switched off from controls 36 in the monitor's frame/housing 20. This provides additional assurance and control of user privacy.

The system of the present invention receives display image date from a personal computer using common display standards such as VGA or DVI. Additionally, it may accept common video input standards such as Component, High Definition, or Composite video. The system will also include a video connection from the camera to the CPU, an audio connection from the microphone to the CPU, and potentially an audio line from the CPU to the Monitor to drive internal speakers. The device will not require any additional support software, and may be used with any of a variety of Internet video telecommunications applications, such as iChat, VIP Messenger, WEB CHAT, or ICU Video Chat. It essentially acts as a conglomeration of all the peripherals ordinarily utilized for video chat/conferencing, with the improved functionality of a behind-screen camera. As pictured in FIG. 9, the invention will enable two-way video communication to take place without the annoying problems of broken eye-line. Users can communicate face-to-face and respond naturally to all facial emotional cues.

According to another preferred embodiment, the system consists of a color video display monitor, which makes use of Organic Light Emitting Diode (OLED) technology or other emissive display technology in order to form its images, and a miniature color video camera, which has the syncable shutter speed capacity of faster than 1/60th of a second. This combined camera/screen is integrated into a package containing a small computer that is capable of Internet connection, and contains video-chat software. The device stands alone with only a power connection and a connection to the Internet, and may be used to communicate through two-way video conferencing without the broken eye-line problem.

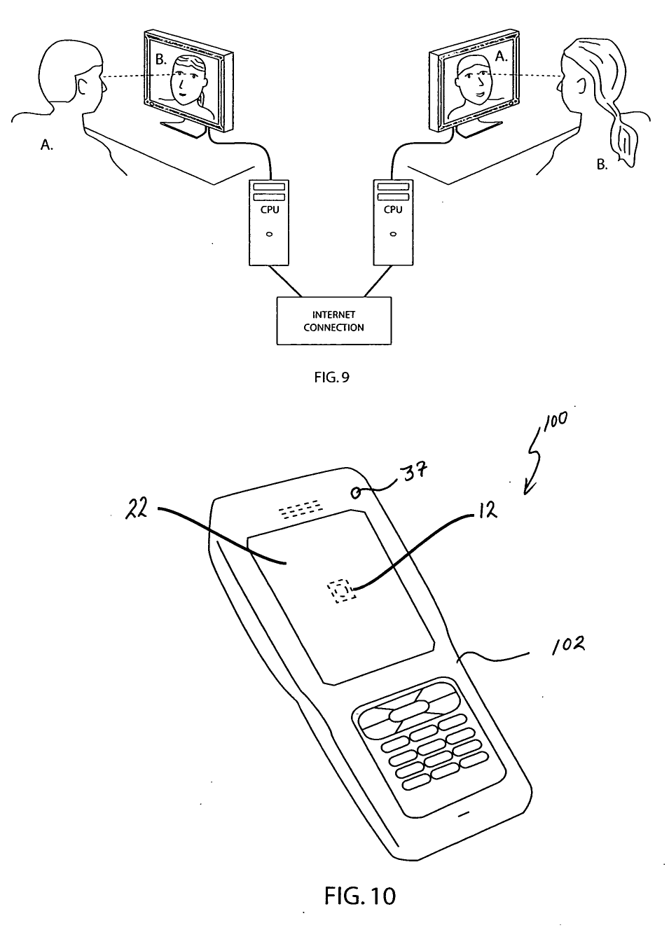

According to another preferred embodiment, as depicted in FIG. 10, the system 100 consists of a color video display monitor 22, which makes use of Organic Light Emitting Diode (OLED) technology or other emissive display technology in order to form its images, and a miniature color video camera 12, which has the syncable shutter speed capacity of over 1/60th of a second. This combined display/camera unit is incorporated into a wireless handheld device 102 allowing face-to-face wireless video communication between two parties without the broken eye-line problem.

The invention can be incorporated into handheld devices such as cellular telephones, two-way pagers, PDAs or any other handheld wireless Internet enabled communication device. The integrated video camera 12 may additionally be used as a standard still camera, as is popular on many cellular telephones today.

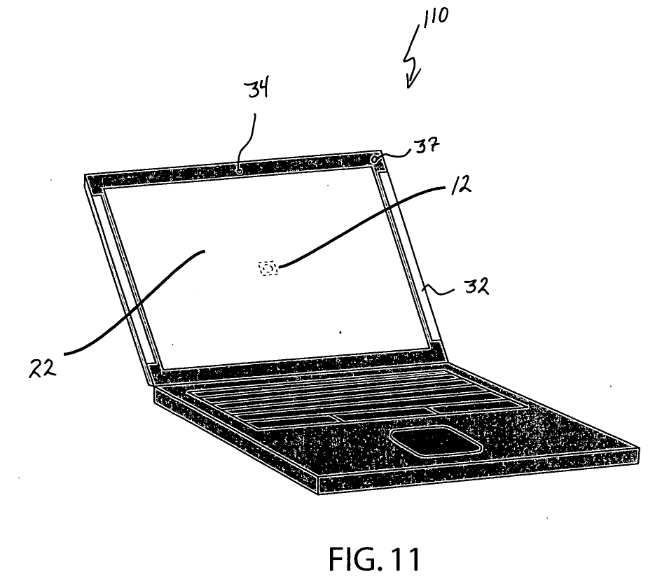

According to yet another preferred embodiment as disclosed in FIG. 11, the system 10 consists of a laptop computer 110 having a color video display monitor 22, which makes use of Organic Light Emitting Diode (OLED) technology or other emissive display technology in order to form its images, and a miniature color video camera 12, which has the syncable shutter speed capacity of faster than 1/60th of a second. This combined camera/screen is integrated into a package containing a small computer that is capable of Internet connection, and contains video-chat software. The device functions as an ordinary laptop computer, but is enabled with a camera capture and lighting system that makes it ideal for two way video conferencing without the broken eye-line problem.

The invention is bundled with appropriate video chat software that enables the user to log in to the service and initiate or receive two way video communication. The invention is similar to the first embodiment except that it is an entirely self-contained portable system that may be used for video chat anywhere that an Internet connection is available.

In accordance with another preferred embodiment, it is possible to implement provision for autostereoscopic display for each of the aforementioned embodiments.

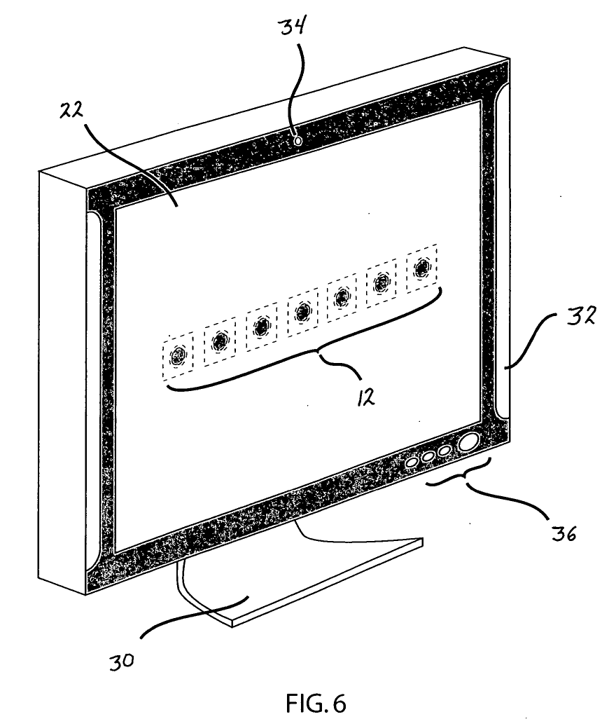

Since OLED technology is capable of the high refresh rates necessary for time multiplexed autostereoscopic display methods, these methods can be easliy incorporated into each of the previously mentioned embodiments adding the feature of 3-Dimensional capture and Display to each device. FIG. 5 shows a basic representation where two cameras 12 are placed behind the OLED display matrix 14. This configuration enables stereoscopic video capture. FIG. 6 illustrates an array of multiple video cameras 12 placed in a row behind the display matrix 14. This multiple camera configuration enables wide parallax video capture for use with a multiple-angle autostereoscopic display screen.

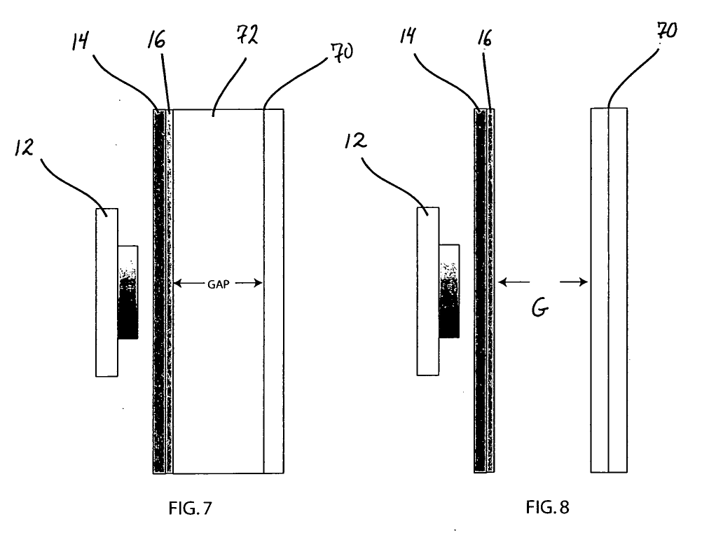

In both 3D embodiments, it is preferred to add an additional layer of liquid crystal as the front most layer of the display screen. FIG. 7 shows a cross section of the autostereoscopic capture and display configuration according to an embodiment of the invention. The cameras 12 are placed behind the OLED display matrix 16, which is backed by a dark neutral density filter 14. The display is separated from a Pi-Cell Liquid crystal shutter plate 70 by a thick transparent glass or plastic window 72 that provides structural stability and ensures precision of separation. FIG. 8 illustrates a cross section of a second embodiment of the autostereoscopic capture and display configuration. The cameras 12 are placed behind the OLED display matrix 16, which is backed by a dark neutral density filter 14. The display is separated from a Pi-Cell liquid crystal shutter plate 70 by an air gap G.

Each camera 12 in the array must have a capture frame rate equivalent to the frame rate of the OLED display. In order to capture complete images while looking through a cycling Pi-Cell parallax barrier in addition to a cycling OLED display, the camera must have a suitably fast shutter speed that is synced to capture frames between the periods of time when the emissive OLED elements directly in front of the camera are activated. Frames are captured for each instance that a transparent active region of the Pi-Cell parallax barrier is visible to the camera, and each of the several frames captured are additively merged to form a single full-screen output image for that camera. By this method, each camera in an array may have identical shutter speeds, but will each have slightly offset sync timing and will each capture and merge frames at different times in order to create full-screen captured frames. A display of this type enables two users to view each eye-to-eye and in 3-D.

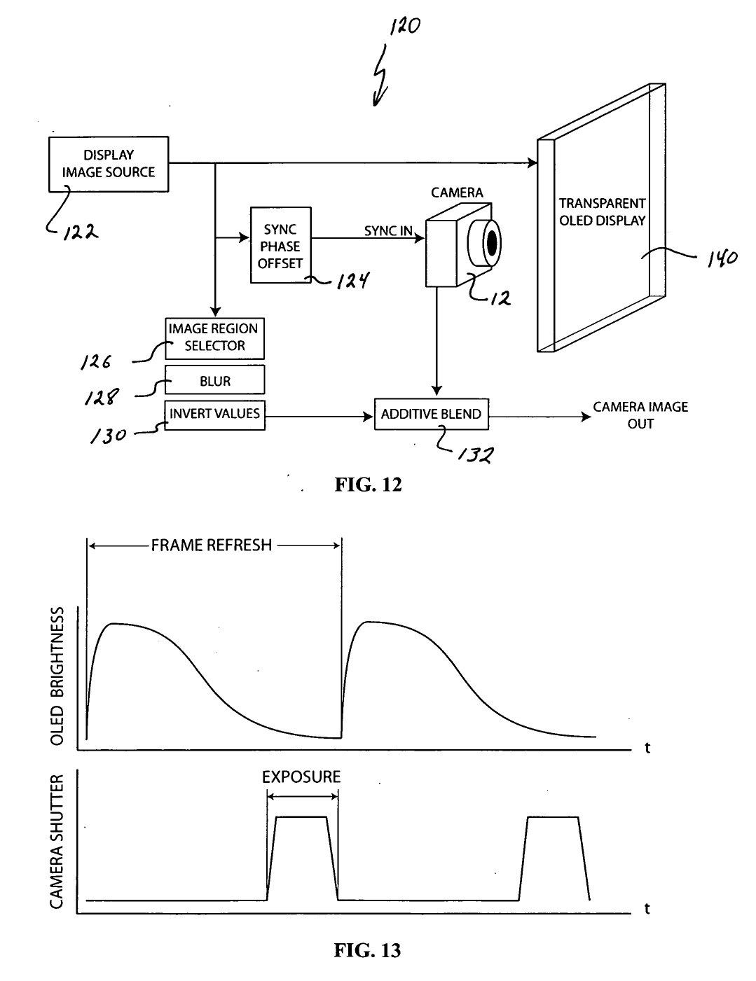

FIG. 12 shows a flowchart block diagram representation of the method by which a clean output image is derived from a video camera placed behind a transparent emissive OLED display screen. FIG. 13 shows a graphical timing diagram of the method of deriving the clean output image.

The display image source 122 will most likely be the image output of a computer graphics card, or the graphical output of any handheld or other digital device that is intended to be displayed on the screen 140.

The frame rate and phase characteristics of the display image source 122 are offset in time (i.e. by sync phase offset module 124) and used to drive the camera shutter. The phase is set so that the camera acquires is images when the region of screen through which it looks is at its minimum level of illumination. As shown in the graphs of FIG. 13, the camera shutter “exposure” occurs when the OLED brightness is at its lowest point, which is generally at the end of the frame refresh cycle. In view of the various OLED driving methods and hardware configurations, the level of illumination fir activiation of the camera shutter can be anywhere from being less than 1/50th the full brightness, like CRT line scanning displays, to possibly as high as ½ the full brightness if it is some kind of active matrix that holds a charge for a long time. OLED displays come in both varieties (i.e., passive and active matrix addressing systems).

It is of interest to note that passive addressed OLED displays are more easily constructed to be transparent, but do not typically have high resolutions or are not capable of displaying as many colors as active matrix displays. In a preferred embodiment of the present invention, the type of OLED display most likely to be used is one having a transparent cathode and/or anode, in conjunction with a TFT bus system. This type of display is capable of full color, high resolution and brightness for high refesh rates, and is transparent to light. This is in contrast to the type of screen built on an opaque common anode or cathode, which renders the finished screen opaque.

In order to remove any residual OLED illumination from the captured image, an active subtraction method may be used. Image data is first processed by some form of Image Region Selector 126. This module selects a small region of the total display image source (the region that is visible by the camera) and enlarges it to a resolution matching that of the camera output. The selector may employ some form of pixel interpolation in order to accomplish a smooth enlargement, though the region selected will contain a very few number of pixels. A secondary blur 128 may then be applied in order to approximate the camera's view of the OLED display as viewed from such a short optical distance. The brightness and color values of the image are then inverted (130) and additively blended (132) with the camera output image. With the blend mode set to the appropriate value and the regional selection and blur properly adjusted, any residual OLED interference will be effectively removed.

Additional Functions of Integrated In-Screen Video Cameras

A video camera installed behind the display screen may be used as a light-level sensor to control the integrated illumination system.

Two or more video cameras may be used in conjunction to control the position of a mouse pointer, thereby making screen-pointing a hands-free procedure, allowing both of the users hands to remain on the keyboard during computer use.

Two or more video cameras may be used in conjunction to track the eye or head position of the user in order to position the optimal viewing region of an autostereoscopic embodiment of the display.

This pertains to the field of remote-eye tracking, wherein one or two cameras are trained on an observer. “Remote” distinguishes the technology from eye-tracking systems that are worn on the head. The cameras of a remote head tracker view light of infared LEDs that reflects from the observer's corneas. The camera signals are then processed in order to determine the observer's point of visual fixation at a given time. This technology is used in cognitive research, for military simulation research, and is being tested as a computer interface for disabled people.

An example eye tracker is made by Applied Science Laboratories and can be found at http://press.arrivenet.com/tec/article.php/633712.html, which is incorporated herein by reference.

A related patent for remote eye tracking is U.S. Pat. No. 6,090,051 to Marshall, which disclosures a method and apparatus for eye tracking and monitoring pupil dilation to evaluate cognitive activity, the entire contents of which is incorporated herein by reference.

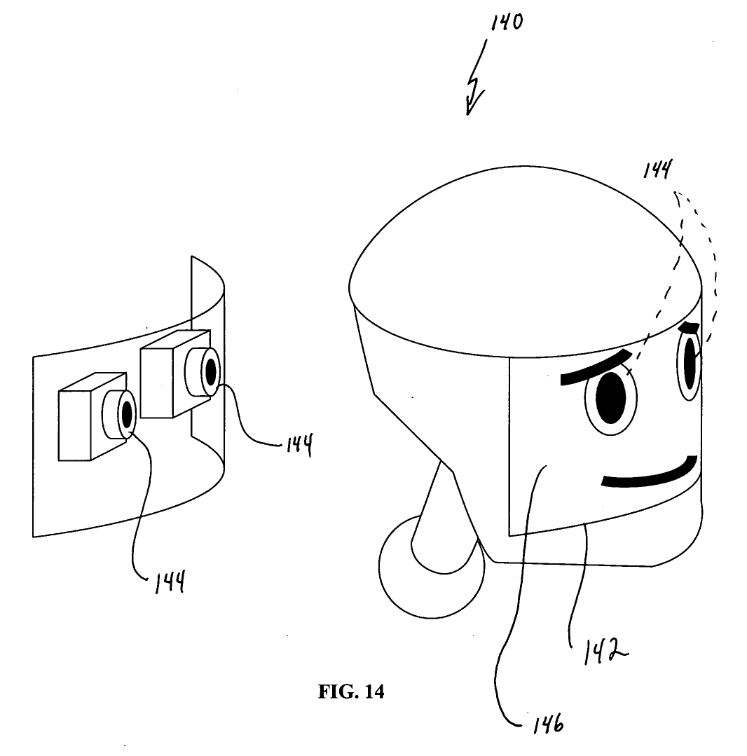

In one embodiment of the invention, a flat or curved OLED display 142 is used to form an expressive face for a robot, or some other automation intended to interact in a face-to-face manner with human users (See FIG. 14). Cameras 144 behind the display surface 146 would interface with the machine vision processing systems of the robot, and the display surface 146 would be connected to the output of the robot's video graphics card. The display 146 would show a computer generated ‘robot face’ 140 that is capable of interactive expression. This system would enable the machine to see by means of large or multiple cameras 144 and to produce real-time facial expressions, without the aesthetic interference of visible cameras or machine vision devices. Additionally, such a display 142 integrated into a robot head could enable the robot to act as a two-way video communication device, whereby the camera-screen system is used for eye-to-eye video chat with a second person, as discussed in previously mentioned embodiments.

While there have been shown, described and pointed out fundamental novel features of the invention as applied to preferred embodiments thereof, it will be understood that various omissions, substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed, described or suggested form or embodiment as a general matter of design choice. It is the intention, therefore, to be limited only as indicated by the scope of the claims appended hereto.

What is claimed is:

1. An apparatus for maintaining eye contact during person to person video telecommunication, the apparatus comprising:
a display device for conducting person to person video telecommunications, said display device having a display matrix; and
at least one video camera disposed behind said display matrix, said video camera having capture frame rate equivalent to a frame rate of the display device.

2. The apparatus according to claim 1, wherein said display device comprises an organic light emitting diode (OLED) display.

3. The apparatus according to claim 1, wherein said display device further comprises substrate layer disposed between the display matrix and said video camera, said substrate layer preventing light from said display matrix from being exposed to said video camera.

4. The apparatus according to claim 1, wherein said display device further comprises a microphone for use in conjunction with said video camera.

5. The apparatus according to claim 1, wherein said video camera comprises a syncable shutter speed of greater than 1/60th of a second.

6. The apparatus according to claim 1, wherein said video camera and said display device are housed in the same display device housing.

7. The apparatus according to claim 1, wherein said video camera and said display device are contained within a portable device.

8. The apparatus according to claim 7, wherein the portable device is one selected from a group consisting of a personal digital assistant (PDA), a cellular telephone, a two way pager and a laptop computer.

9. The apparatus according to claim 1, further comprising a plurality of video cameras disposed behind the display device.

10. An apparatus for maintaining eye contact during person to person video telecommunication, the apparatus comprising:
a display device for providing a display of a display image source and being capable of being used to conduct person to person video telecommunications, said display image source having a frame rate and phase characteristics; and
a video camera disposed behind said display matrix and having a shutter, said frame rate and phase characteristics of the display image source being used to drive said camera shutter.

11. The apparatus according to claim 10, wherein said wherein said frame rate and said phase characteristics are offset in time.

12. The apparatus according to claim 11, wherein said offset in time sets the phase characteristic such that said camera shutter exposes in time when said display device is at a minimum illumination level.

13. The apparatus according to claim 10, wherein said camera comprises a capture frame rate, said capture frame rate being equivalent to a frame rate of said display device.

14. A method for maintaining eye contact during person to person video telecommunication, the method comprising:
providing a display device;
providing at least one video camera positioned behind the display device; and
synchronizing the at least one video camera with the frame refresh rate and phase characteristics of a display image source.

15. The method according to claim 14, wherein said display device is an organic light emitting diode (OLED) display device.

16. The method according to claim 14, further comprising driving the at least one video camera using frame rate and phase characteristics of a display image source.

17. The method according to claim 16, wherein said the phase of the display image source is set so as enable the at least one video camera to acquire images when said display device is at a minimum level of illumination.

18. The method according to claim 14, further comprising synchronizing a shutter speed of the at least one video camera with a frame rate of the display device.

19. The method according to claim 18, wherein the at least one video camera has a shutter speed faster than the frame rate of the display device.
